(19) United States
(12) Patent Application Publication
(10) Pub. No.: US 2008/0238598 A1
(43) Pub. Date: Oct. 2, 2008

(54) INDUCTOR

(76) Inventors: Shu-Hui CHEN, Taoyuan Hsien (TW); Chi-Chih Yu, Taoyuan Hsien (TW)

Correspondence Address: BIRCH STEWART KOLASCH & BIRCH, PO BOX 747, FALLS CHURCH, VA, 22040-0747, US

(21) Appl. No.: 12/016,885

(22) Filed: Jan. 18, 2008

(30) Foreign Application Priority Data
Mar. 30, 2007 (TW) 096111220

(51) Int. Cl. H01F 27/02

(52) U.S. Cl. 336/83

(57) ABSTRACT

An inductor includes a first core, a second core, a fixing element and a winding. The first core has a first recess. The second core is coupled to the first core. The fixing element is disposed in the first recess. The winding is wound around the fixing element and has a plurality of connecting portions.

### CROSS REFERENCE TO RELATED APPLICATIONS

This Non-provisional application claims priority under 35 U.S.C. §119(a) on Patent Application No(s). 096111220 filed in Tai+an, Republic of China on Mar. 30, 2007, the entire contents of which are hereby incorporated by reference.

### BACKGROUND OF THE INVENTION

1. Field of Invention

The invention relates to an inductor.

2. Related Art

A circuit in an electronic device, such as a power supply or a power converter, usually operates in a high-frequency switching condition, so the electro-magnetic interference (EMI) may easily occur and thus influence the operation of the electronic device. The EMI is classified into the radiated EMI and the conducted EMI according to the transfer method. The radiated EMI is transferred in an open space, while the conducted EMI is transferred through wires of the circuit.

In order to eliminate the EMI effectively, an inductor corresponding to the type of the to-be-eliminated noise is correspondingly disposed in the electronic device. For example, if the common mode noise has to be eliminated, an inductor capable of eliminating the common mode noise is disposed in the electronic device. If the differential mode noise has to be simultaneously eliminated, another inductor capable of eliminating the differential mode noise is added to the electronic device. However, two inductors have to be added to waste the space in the electronic device so that the electronic device cannot be easily miniaturized. In addition, many elements are used so that the manufacturing cost is increased.

In order to solve the above-mentioned problem, as shown in FIG. 1, a conventional inductor 1 including a magnetic-conducting bobbin 11, a primary winding 12, a secondary winding 13, a core set 14 and a frame 15 is provided. The primary winding 12 and the secondary winding 13 are respectively wound around two sides of the magnetic-conducting bobbin 11. The core set 14 is constituted by two cores 14a and 14b. First ends of the cores 14a and 14b respectively penetrate through the magnetic-conducting bobbin 11, the primary winding 12 and the secondary winding 13 in opposite directions. Second ends of the cores 14a and 14b contact with each other and are connected to each other outside the magnetic-conducting bobbin 11. The frame 15 fixes the core set 14. The inductor 1 mainly has the magnetic-conducting property through the magnetic-conducting bobbin 11, and the combination of the magnetic-conducting bobbin 11, the primary winding 12, the secondary winding 13 and the core set 14 has the property of the common mode inductor.

In addition, the lines of magnetic forces of the primary winding 12 and the secondary winding 13 do not cross each other so that the property of the differential mode inductor is obtained. Although the inductor 1 can eliminate the EMI, it is difficult to shape the magnetic-conducting bobbin 11 using a magnetic-conducting material so that the manufacturing cost is increased and the production period of time is lengthened. In addition, no matter how the assembling is made, the space consumption caused by the magnetic-conducting bobbin 11 cannot be avoided, and the design of the inductor 1 cannot enhance the property of withstanding the current.

Therefore, it is an important subject to provide an inductor, which has the reduced size and the enhanced property of withstanding the current, and can be produced with the shortened period of time and the reduced manufacturing cost.

### SUMMARY OF THE INVENTION

In view of the foregoing, the invention is to provide an inductor, which has the smaller size and the enhanced property of withstanding the current, and can be manufactured with the shortened period of time and the reduced manufacturing cost.

To achieve the above, the invention discloses an inductor including a first core, a second core, a fixing element, a winding and a fixing frame. The first core has a first recess. The second core is coupled to the first core. The fixing element is disposed in the first recess. The winding is wound around the fixing element. The fixing frame is assembled with the first and second cores.

As mentioned above, the inductor of the invention has the first core and the second core, which are connected together and simultaneously connected to and disposed on the base of the fixing frame. The fixing element is disposed between the first and second cores so that the winding can be fixed to the fixing element. The connecting portions of the winding penetrate through the through hole of the fixing frame and are thus electrically connected to the pins on the fixing frame. Compared with the prior art, the size of the inductor can be significantly reduced so that the manufacturing cost can be decreased, and the space occupied by the facture can also be reduced so that the customer can flexibly utilize the space of the product. In addition, the winding area of the winding can be enlarged according to the fixing element so that the property of withstanding the current can be enhanced. Furthermore, the inductor can be quickly assembled and produced so that the production time period can be shortened and the production cost can be lowered, and the quality and the stability of the inductor can be enhanced.

### BRIEF DESCRIPTION OF THE DRAWINGS

The present invention will become more fully understood from the subsequent detailed description and accompanying drawings, which are given by way of illustration only, and thus are not limitative of the present invention, and wherein:

FIG. 1 is a schematic illustration showing a conventional inductor;

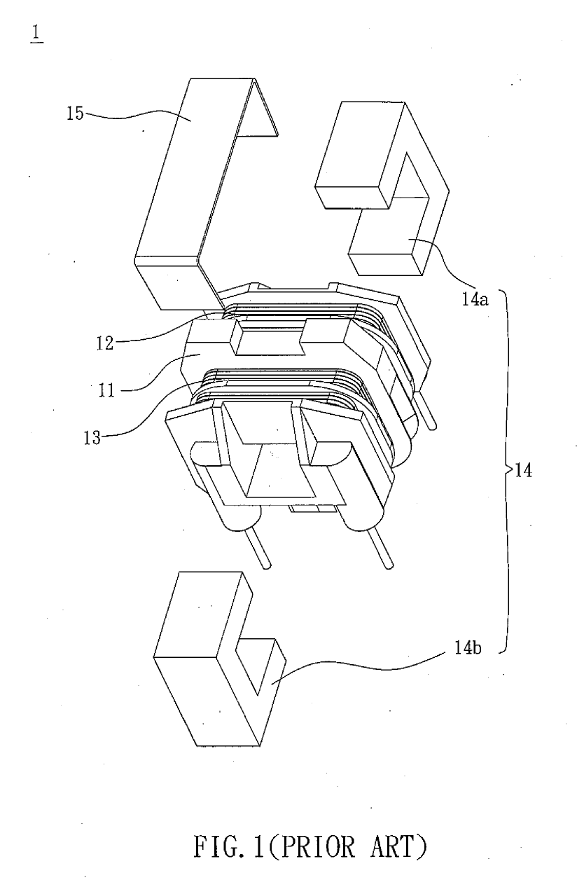

FIG. 2 is a schematic illustration showing an inductor according to a first embodiment of the invention;

FIG. 3 is a schematically exploded view showing the inductor of FIG. 2, wherein a fixing element of the inductor is connected to a first core;

FIG. 4 is a schematically exploded view showing an inductor according to a second embodiment of the invention, wherein a fixing element of the inductor is connected to a second core;

FIG. 5 is a bottom view showing the inductor of FIG. 2;

FIG. 6 is a bottom view showing an inductor according to a third embodiment of the invention, wherein a fixing frame of the inductor has a notch formed on one side of a base thereof;

FIG. 7 is a bottom view showing an inductor according to a fourth embodiment of the invention, wherein a fixing frame of the inductor has a notch, which is in communication with a through hole; and

FIG. 8 is a schematic illustration showing an inductor according to a fifth embodiment of the invention.

### DETAILED DESCRIPTION OF THE INVENTION

The present invention will be apparent from the following detailed description, which proceeds with reference to the accompanying drawings, wherein the same references relate to the same elements.

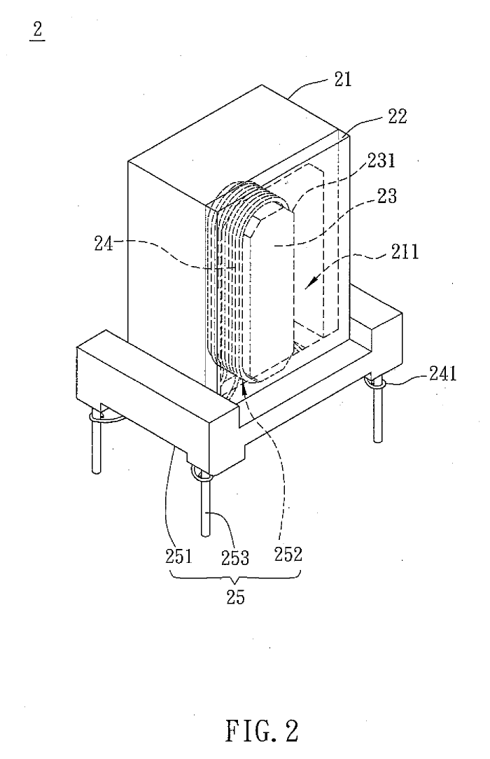

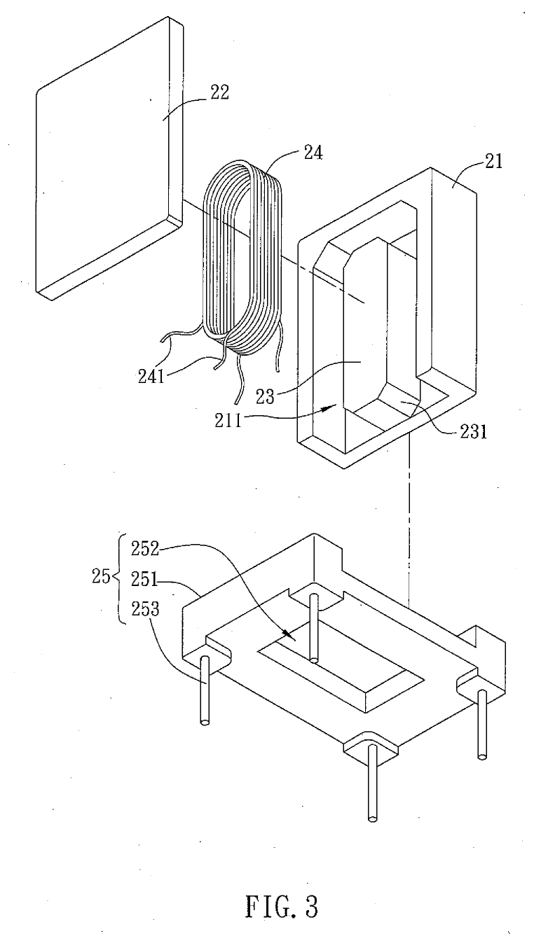

Referring to FIGS. 2 and 3, an inductor 2 according to a first embodiment of the invention includes a first core 21, a second core 22, a fixing element 23, a winding 24 and a fixing frame 25. In this embodiment, the first core 21 has a first recess 211.

The second core 22 of this embodiment is disposed on and connected to the first core 21. The shape of the second core 22 is not particularly restricted and may be implemented as a long plate-like shape. The first core 21 can be connected to the second core 22 by way of adhering.

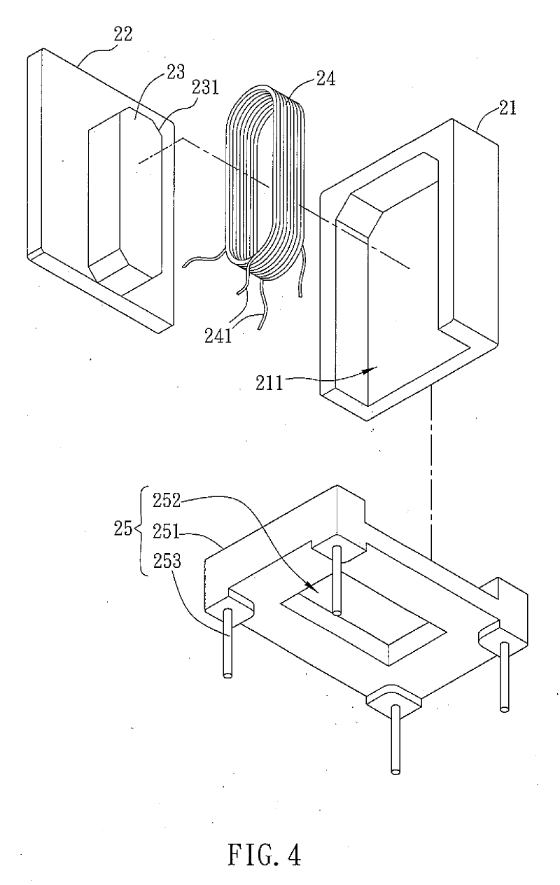

As shown in FIG. 2 again, the first core 21 has the first recess 211, and the fixing element 23 is disposed in the first recess 211 and between the first core 21 and the second core 22. In addition, the fixing element 23 has a plurality of chamfers 231 disposed on a periphery of the fixing element 23. The implemented fixing element 23 has four chamfers 231 respectively disposed at four top corners of the fixing element 23. The position of the fixing element 23 of this embodiment is not particularly restricted. When being implemented, the fixing element 23 can be disposed in the first core 21 (i.e., the first recess 211), as shown in FIG. 3, and eccentrically disposed adjacent to one side of the first recess 211. Alternatively, the fixing element 23 can be disposed in the second core 22 and eccentrically disposed adjacent to one side of the second core 22, as shown in FIG. 4. Of course, when being manufactured, the fixing element 23 can further be integrally formed with the first core 21 as a monolithic piece, as shown in FIG. 3, or integrally formed with the second core 22 as a monolithic piece, as shown in FIG. 4. In addition, the material of the fixing element 23 is the same as that of the first core 21 or the second core 22, and the shape of the fixing element 23 is a rectangular column.

The winding 24 of this embodiment is wound around the fixing element 23 and has a plurality of connecting portions 241. In addition, the fixing element 23 of this embodiment has the chamfers 231. Thus, the winding 24 is restricted by the chamfers 231 and cannot be easily moved. In addition, since the shape of the fixing element 23 is the rectangular column, the winding area of the winding 24 can be enlarged and the property of withstanding the current can be enhanced.

As shown in FIGS. 2 and 3, the fixing frame 25 of this embodiment has a base 251, a through hole 252 and a plurality of pins 253. The base 251 is connected to the first core 21 and the second core 22, and the through hole 252 is disposed on the base 251 and disposed corresponding to the first recess 211. The pins 253 are disposed on one side of the base 251 and disposed opposite to the first core 21 and the second core 22. The material of the implemented base 251 of this embodiment is a non-magnetic material, such as a plastic material. In addition, the positions of the pins 253 on the base 251 are not particularly restricted. In practice, the pins 253 can be disposed at four top corners of the base 251, or may be paired and disposed on two opposite sides of the base 251.

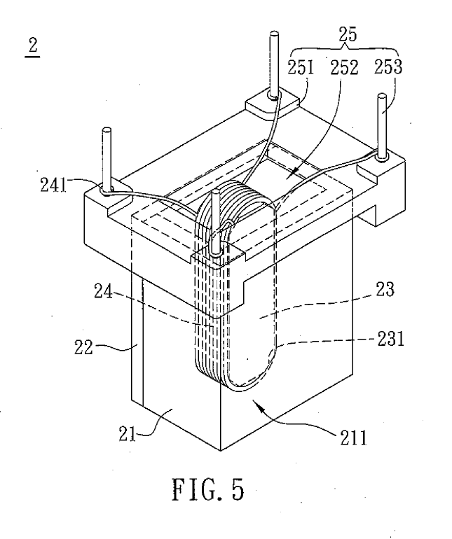

FIG. 5 is a bottom view of FIG. 2. As shown in FIGS. 2 and 5, When the inductor 2 is being assembled, the connecting portions 241 of the winding 24 penetrate through the trough hole 252 and are thus electrically connected to the pins 253.

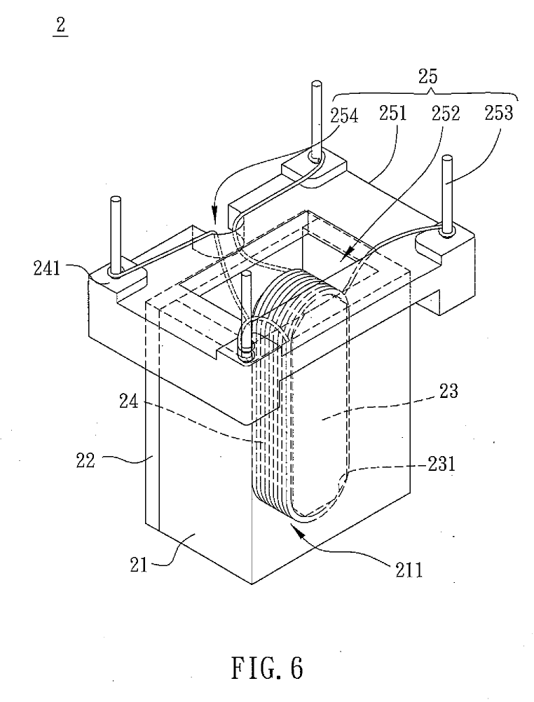

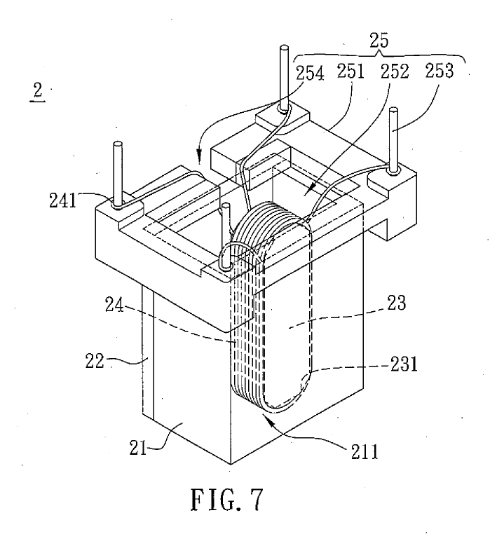

FIGS. 6 and 7 are bottom views showing inductors according to other embodiments of the invention. As shown in FIGS. 6 and 7, the fixing frame 25 further has a notch 254 disposed on one side of the base 251, wherein at least one of the connecting portions 241 penetrates through the notch 254. Herein, two connecting portions 241 penetrate through the notch 254 and are electrically connected to the pins 253. As shown in FIG. 6, the notch 254 is disposed on the one side of the base 251. Of course, the notch 254 can further be connected to and in communication with the through hole 252, as shown in FIG. 7. Therefore, the notch 254 of this embodiment is for fixing the connecting portions 241 and the inductor 2 can be knotted from the notch 254 to facilitate the production.

In the inductor 2, the first core 21 is connected to the second core 22 so that the winding 24 can be fixed between the first core 21 and the second core 22 through the fixing element 23. In this manner, the size of the inductor 2 can be significantly reduced so that the manufacturing cost can be decreased, and the space occupied by the facture can also be reduced so that the customer can flexibly utilize the space of the product. In addition, the inductor 2 can be quickly assembled and produced so that the production time period can be shortened and the production cost can be lowered, and the quality and the stability of the inductor 2 can be enhanced.

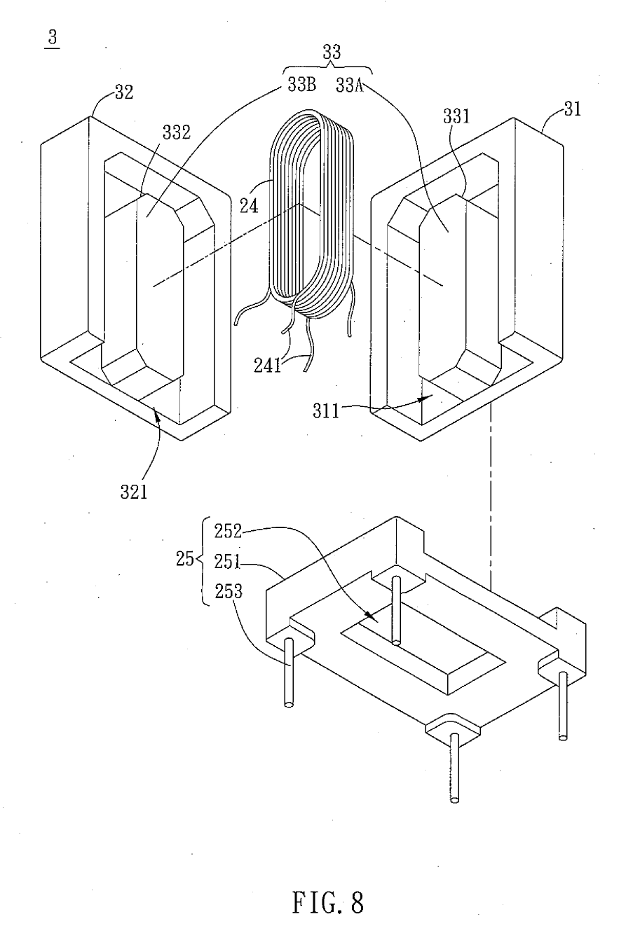

As shown in FIG. 8, an inductor 3 according to a fifth embodiment of the invention includes a first core 31, a second core 32, a fixing element 33, a winding 24 and a fixing frame 25.

The winding 24 and the fixing frame 25 of the fifth embodiment are the same as those of the inductor 2 (see FIG. 2), so detailed descriptions thereof will be omitted.

As shown in FIG. 8, the inductor 3 of this embodiment differs from the inductor 2 of the first embodiment in that the second core 32 has a second recess 321. When the second core 32 is connected to the first core 21, the second recess 321 corresponds to a first recess 311 of the first core 31.

The fixing element 33 has a first fixing portion 33A and a second fixing portion 33B. The first fixing portion 33A has a plurality of first chamfers 331 disposed on a periphery of the first fixing portion 33A. The first fixing portion 33A is disposed in the first recess 311 of the first core 31, and is disposed adjacent to one side of the first recess 311. The second fixing portion 33B has a plurality of second chamfers 332 disposed on a periphery of the second fixing portion 33B. The second fixing portion 3313 is disposed in the second recess 321 of the second core 32 and is disposed adjacent to one side of the second recess 321. As for the positions of the first chamfers 331 and the second chamfers 332, the first chamfers 331 are respectively disposed at four top corners of the first fixing portion 33A, and the second chamfers 332 are respectively disposed at four top corners of the second fixing portion 33B.

In this embodiment, the first fixing portion 33A and the first core 21 are integrally formed as a monolithic unit, and the second fixing portion 33B and the second core 32 are integrally formed as a monolithic unit. In addition, when the first core 31 is connected to the second core 32, the first fixing portion 33A is disposed corresponding to and electrically connected to the second fixing portion 3313 so that the winding 24 can be fixed onto the fixing element 33.

In this embodiment, the detailed effects of the inductor 3 have been described according to the inductor 2 of the first embodiment, so detailed descriptions thereof will be omitted.

In summary, the inductor of the invention has the first core and the second core, which are connected together and simultaneously connected to and disposed on the base of the fixing frame. The fixing element is disposed between the first and second cores so that the winding can be fixed to the fixing element. The connecting portions of the winding penetrate through the through hole of the fixing frame and are thus electrically connected to the pins. Compared with the prior art, the size of the inductor can be significantly reduced so that the manufacturing cost can be decreased, and the space occupied by the facture can also be reduced so that the customer can flexibly utilize the space of the product. In addition, the winding area of the winding can be enlarged according to the fixing element so that the property of withstanding the current can be enhanced. Furthermore, the inductor can be quickly assembled and produced so that the production time period can be shortened and the production cost can be lowered, and the quality and the stability of the inductor can be enhanced.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. An inductor comprising:
a first core having a first recess;
a second core coupled to the first core;
a fixing element disposed in the first recess;
a winding wound around the fixing element; and
a fixing frame assembled with the first core and the second core.

2. The inductor according to claim 1, wherein a material of the fixing element is the same as that of the first core or the second core.

3. The inductor according to claim 1, wherein the fixing element is a rectangular column.

4. The inductor according to claim 1, wherein the fixing element has a plurality of chamfers disposed on a periphery of the fixing element.

5. The inductor according to claim 1, wherein the fixing element is eccentrically disposed adjacent to one side of the first recess.

6. The inductor according to claim 1, wherein the fixing element and the first core are integrally formed as a monolithic unit.

7. The inductor according to claim 1, wherein the fixing element is eccentrically disposed adjacent to one side of the second core.

8. The inductor according to claim 1, wherein the fixing element and the second core are integrally formed as a single unit.

9. The inductor according to claim 1, wherein the fixing element comprises:
a first fixing portion disposed in the first core; and
a second fixing portion disposed in the second core corresponding to the first fixing portion.

10. The inductor according to claim 9, wherein the first fixing portion or the second fixing portion has a plurality of chamfers disposed on a periphery of the fixing portion.

11. The inductor according to claim 9, wherein the first fixing portion and the first core are integrally formed as a monolithic unit.

12. The inductor according to claim 9, wherein the second fixing portion and the second core are integrally formed as a monolithic unit.

13. The inductor according to claim 9, wherein the second core has a second recess, and the second fixing portion is disposed in the second recess and eccentrically disposed adjacent to one side of the second recess.

14. The inductor according to claim 9, wherein the first fixing portion is disposed in the first recess and eccentrically disposed adjacent to one side of the first recess.

15. The inductor according to claim 1, wherein the first core is adhered to the second core.

16. The inductor according to claim 1, wherein the winding has a plurality of connecting portions.

17. The inductor according to claim 16, wherein the fixing frame comprises a base, a through hole and a plurality of pins, the base is assembled with the first core and the second core, the through hole is formed in the base corresponding to the first recess, the pins are disposed on one side of the base, and the connecting portions penetrate through the through hole and are electrically connected to the pins.

18. The inductor according to claim 17, wherein the fixing frame further has a notch disposed on one side of the base, and at least one of the connecting ends penetrates through the notch.

19. The inductor according to claim 18, wherein the notch communicates with the through hole.

20. The inductor according to claim 1, wherein a material of the fixing frame is a non-magnetic material or plastic.
